(19) United States
(12) Patent Application Publication
(10) Pub. No.: US 2025/0019217 A1
(43) Pub. Date: Jan. 16, 2025

(54) AERIAL LIFT WITH COMBUSTION-ENGINE OR ELECTRIC-MOTOR DRIVE

(71) Applicant: HAULOTTE GROUP, LORETTE (FR)

(72) Inventor: Didier DESSEUX, SOLAIZE (FR)

(21) Appl. No.: 18/834,890

(22) PCT Filed: Feb. 6, 2023
(86) PCT No.: PCT/EP2023/052832

§ 371 Date: Jul. 31, 2024

(30) Foreign Application Priority Data
Feb. 7, 2022 (FR) 2201042

(51) Int. Cl. B66F 11/04; B66F 3/25; F15B 1/26; F15B 15/18

(52) U.S. Cl. CPC B66F 11/044; B66F 3/25; F15B 1/26; F15B 15/18

(57) ABSTRACT

The lift (1) comprises a drive (30), a chassis that is capable of translational movement on the ground, a platform, an elevating structure and a hydraulic system (S) comprising a reservoir (130), hydraulic actuators and a circulation circuit (140). The circulation circuit comprises a pump unit (170), which can be driven by the drive to deliver a fluid into a delivery line (172) at a delivery pressure which can be varied according to a pressure regulation, a main distribution unit (190), which is connected to the delivery line and which controls the actuation of first actuators (20, 120) acting on parts of the elevating structure (110), a boost unit (180), which is connected to the delivery line by a branched-off supply line (181) and which sends the fluid from the latter into a boost line (182) by regulating the pressure thereof to a boost pressure having a preset value, and an accessory distribution unit (200), which is connected to the boost line and which controls the actuation of second actuators (50, 70, 80, 81) acting on accessory parts (40, 60, 13A), including a brake release device.

The present invention relates to an aerial lift.

The invention concerns more specifically lifts, the translation of which on the ground, typically by means of wheels, is motor-driven and the components of which of the lifting structure are movable by hydraulic actuators which are actuated by a fluid, typically oil, which circulates in an open circuit under the effect of a pump, usually with variable displacement. For example, US 2021/261102 discloses an aerial lift, the hydraulic system of which comprises a pump driven by a motor and sucking a fluid from a reservoir to send same to a manifold unit where first valves control the actuation of hydraulic actuators moving a rotary turret and an extensible arm of the aerial lift, whereas second valves of the manifold unit control the actuation of hydraulic actuators acting on the brake release of the wheels of the lift. In US 2021/261102, the first and second valves are all connected to the pump in the same way.

Such type of lift often comprises an internal combustion engine the power output of which is used to drive both the variable displacement pump and a hydraulic pump of a hydrostatic transmission, a hydraulic motor of which drives the wheels for translation on the ground. Alternatively, the lift comprises an electric motor-drive which drives the variable displacement pump and the wheels for translation on the ground.

When the lift has an internal combustion engine and uses the aforementioned hydrostatic transmission, it is necessary to equip the lift with a booster pump, driven by the internal combustion engine. The booster pump allows fluid to be fed, under a predetermined fixed pressure, into the closed circuit of the hydrostatic transmission so as to compensate for leaks and renew the oil, in particular to cool and filter the pump. The discharge of the booster pump is often used also to actuate hydraulic actuators involved in accessory functions, in particular in connection with translation on the ground, such as a brake release of the wheels. Such hydraulic architecture with internal combustion engine is satisfactory, but the booster pump induces a constant energy consumption, even when the lift is controlled to move the lifting structure without being controlled in translation on the ground.

When the lift has an electric motor, the use of a booster pump is no longer necessary to ensure the translation on the ground as such. However, in such case, the hydraulic architecture becomes more complex if the aforementioned accessory functions are to be operated using hydraulic actuators.

More generally, it was found that the hydraulic architectures associated with an internal combustion engine drive and with an electric motor-drive have specific advantages and disadvantages, which tend to make the respective specificities of the two architectures quite different from each other. The design, industrialization and manufacture of the two hydraulic architectures thus entail substantial constraints and costs, which cannot be pooled.

The goal of the present invention is to propose a novel aerial lift which, while being able to have an internal combustion engine version and an electric motor version, is at the same time simpler to design, to industrialize and to manufacture, while optimizing the energy consumption thereof.

To this end, the subject matter of the invention is an aerial lift as defined in claim 1.

One of the ideas underlying the invention is not to use a booster pump as mentioned hereinabove, but to integrate a booster unit, which is not motor-driven and which cooperates with a pressure regulation pump unit, into the hydraulic system of the aerial lift. According to the invention, the booster unit controls the pressure regulation of the pump unit in such a way that (i) the pump unit discharges the fluid with a discharge pressure which, whatever the hydraulic actuators actuated, in particular for the requirements of translation on the ground and/or for the movement of the lifting structure, is always sufficient to enable the actuation of the hydraulic actuators to be actuated and (ii) the hydraulic actuator(s), including the actuator involved in the brake release, which require to be supplied with fluid at a predetermined booster pressure in order to be actuated, are efficiently supplied by the booster unit as soon as the or these hydraulic actuator or actuators are actuated. It results therefrom that the drive of the pump unit of the lift according to the invention can be either an internal combustion engine or an electric motor: in other words, the same hydraulic components can be installed in the same places within a combustion engine-drive lift and within an electric motor-drive lift, as illustrated in more detail thereafter. The design, industrialization and manufacture of a combustion engine version and of an electric version of the lift according to the invention are thereby remarkably improved. In addition, the boost operated by the booster unit of the lift according to the invention is energetically optimized in the sense that the pump unit adapts the hydraulic power thereof to the actual needs: when the lift is not controlled for the purpose of the translation thereof on the ground, all the hydraulic power of the pump unit can be used to actuate the hydraulic actuators acting on the lifting structure, in particular without the need to “needlessly” run a booster pump as mentioned hereinabove; on the other hand, when the lift is controlled solely for the purpose of the translation on the ground, the hydraulic power of the pump unit is limited to supplying the accessory supply line by the booster unit with fluid under the booster pressure. In practice, various embodiments can be envisaged for the pump unit and for the booster unit, as discussed in detail thereafter. Moreover, the invention has a remarkable application to drive axle lifts, also as described in greater detail thereafter.

Advantageous additional features of the aerial lift according to the invention are specified in the other claims.

The invention will be better understood upon reading the following description, given only as an example and making reference to the drawings, wherein:

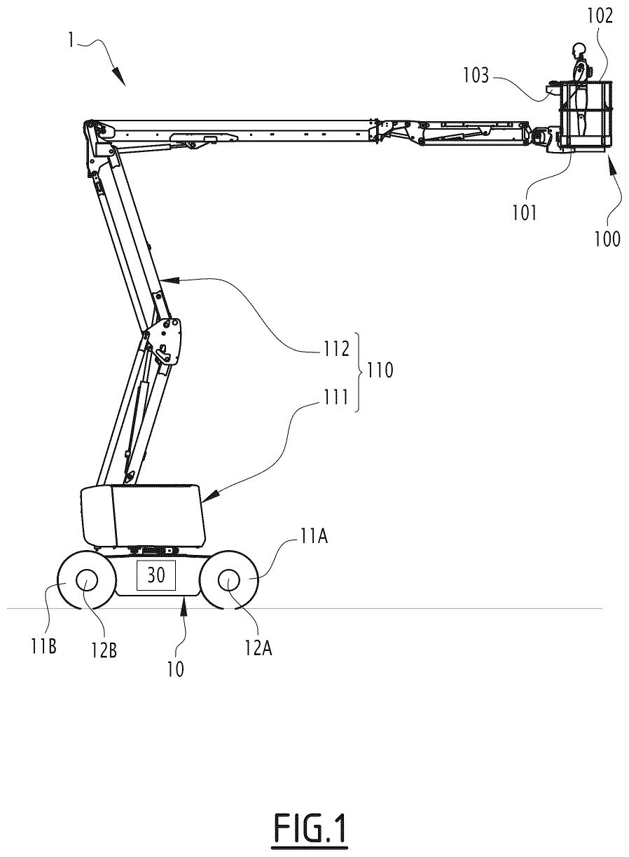

FIG. 1 is an elevation view of an aerial lift according to the invention;

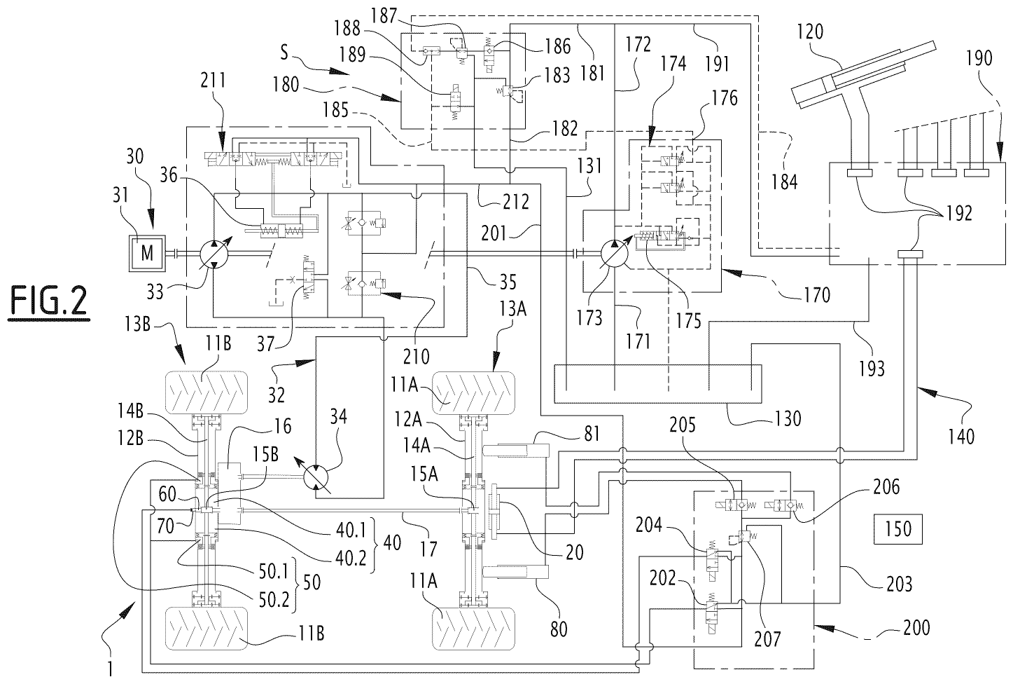

FIG. 2 is a diagram of certain components of the lift shown in FIG. 1, more particularly a hydraulic system of the latter; and

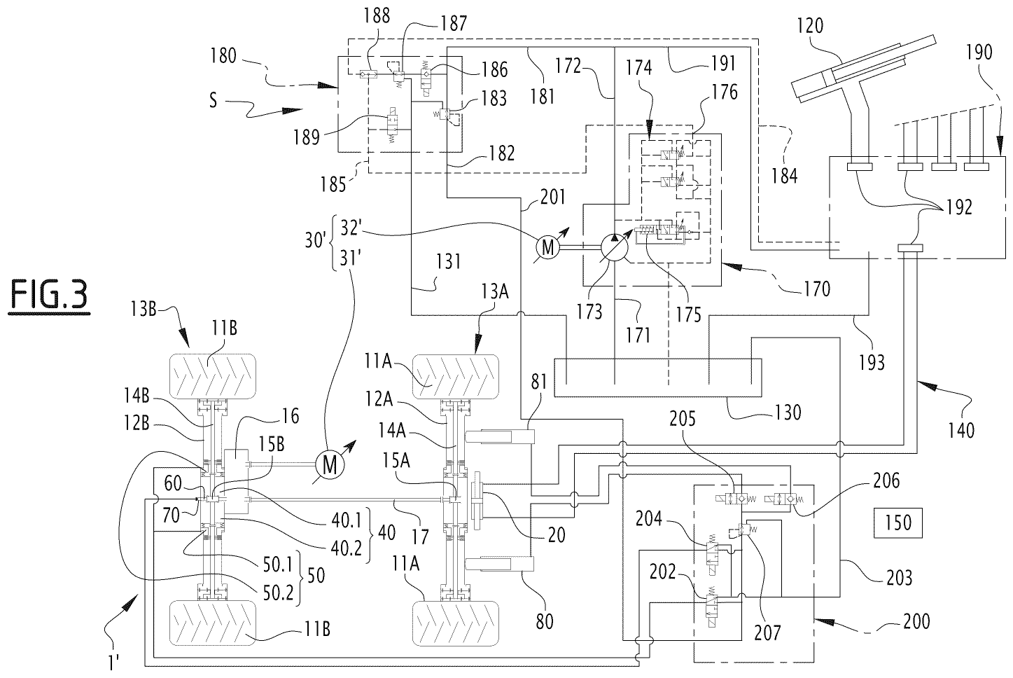

FIG. 3 is a view similar to FIG. 2, illustrating an alternative embodiment for the aerial lift, according to the invention.

FIGS. 1 and 2 show an aerial lift 1 enabling an operator to reach a zone situated at a height in order to carry out work thereon.

As shown in FIG. 1, the aerial lift 1 comprises a chassis 10 resting on the ground.

The chassis 10 is provided with wheels 11A and 11B for the translation thereof. In the preferential embodiment illustrated in the figures, the wheels are divided into a pair of front wheels 11A and a pair of rear wheels 11B. In a variant (not shown), all or part of the front wheels 11A and of the rear wheels 11B can be replaced by tracks for the purpose of translating the chassis 10 on the ground. More generally, the front wheels 11A and the rear wheels 11B are only examples of ground translation members equipping the chassis 10.

The front wheels 11A are steering wheels, being orientable to the left and to the right with respect to a front-to-back geometric axis of the chassis 10, extending parallel to the ground. Such inclination of the wheels 11A makes it possible to rotate the chassis 10 in a corresponding manner with respect to the ground. The wheels 11A can thereby be oriented in an adjustable manner with respect to the chassis 10 to modify the direction along which the chassis 10 translates on the ground and thereby direct the aerial lift 1 on the ground along a trajectory controlled by the operator using the lift. To this end, as shown schematically in FIG. 2, the aerial lift 1 includes a hydraulic actuator 20 which acts on the front wheels 11A so as to adjust the orientation thereof relative to the chassis 10. In practice, the hydraulic actuator 20 is supported by the chassis 10. As an example, the hydraulic actuator 20 is a double-acting power cylinder with a double rod; it is emphasized that such example is not limiting and that other embodiments for the hydraulic actuator 20, as such, are known in the art, more particularly in the field of aerial lifts. In a variant (not shown), the rear wheels 11B are steering wheels, replacing or supplementing the front wheels 11A: in such case, the aerial lift 1 includes a hydraulic actuator, which is similar to the hydraulic actuator 20 but which acts on the rear wheels 11B so as to adjust the orientation thereof relative to the chassis 10.

According to a preferential embodiment, which is implemented herein and which is illustrated schematically in FIG. 2, the front wheels 11A are correspondingly supported by the opposite ends of the same front drive axle 12A and form with the latter a front axle 13A of the chassis 10. Similarly, the rear wheels 11B are correspondingly supported by the opposite ends of the same rear drive axle 12B and form with the latter a rear axle 13B of the chassis 10. The chassis 10 is thereby a chassis with two drive axles, with the proviso that, in a variant not shown, the number of drive axles of the chassis 10 may be equal to or greater than three.

The aerial lift 1 is self-propelled so as to be able to move on the ground on its own. To this end, the aerial lift includes a motor-drive 30 used to drive at least some of the wheels 11A and 11B, herein all the wheels 11A and 11B, so as to move the chassis 10 with respect to the ground. In the embodiment shown in FIG. 2, the motor-drive 30 is by combustion in the sense that same comprises an internal combustion engine 31 the output of which supplies the drive energy needed for the operation of the aerial lift 1. In practice, the internal combustion engine 31 is supported by the chassis 10. In order to ensure transmission between the internal combustion engine 31 and the wheels 11A and 11B, the aerial lift 1 comprises a hydrostatic transmission 32 belonging to a hydraulic system S of the aerial lift, as indicated diagrammatically in FIG. 2. The hydraulic system S uses a fluid, such as oil. The hydrostatic transmission 32 includes a hydraulic pump 33 to which is mechanically connected, the drive output of the internal combustion engine 31, a hydraulic motor 34 the drive output of which is mechanically connected to the wheels 11A and 11B, and a closed circuit 35 wherein the fluid circulates, in a closed loop, between hydraulic motor 34 and hydraulic pump 33. In practice, the specificities of the internal combustion engine 31 and of the hydrostatic transmission 32 are not limiting, since it should be noted that such a hydrostatic transmission and such an internal combustion engine are known as such in the art, more particularly in the field of aerial lifts. Preferentially, the hydraulic pump 33 has a variable displacement which is controlled by a control member 36, such as a power cylinder. In addition, the closed circuit 35 is advantageously equipped with a scavenging valve 37 which regularly withdraws fluid from the closed circuit 35 in order to filter and/or cool same.

To ensure transmission between the hydraulic motor 34 and the wheels 11A and 11B, the front drive axle 12A and rear drive axle 12B each include a transmission shaft 14A, 14B, the opposite ends of which are kinematically connected to the front wheels 11A and rear wheels 11B, respectively, and which advantageously includes a differential 15A, 15B. Moreover, the drive output of the hydraulic motor 34 is connected, via a gearbox 16, to a central transmission shaft 17 the opposite ends of which are connected to the transmission shafts 14A and 14B, respectively, in particular to the respective differential 15A and 15B. In practice, the specificities of the mechanical transmission just described between the hydraulic motor 34 and the wheels 11A and 11B are not limiting.

In any case, the aerial lift 1 includes a brake release device 40 which, in the deactivated state, brakes at least some of the wheels 11A and 11B. Thereby, in the absence of activation of the brake release device 40, the latter mechanically locks the rotation of at least some of the wheels 11A and 11B and thereby prevents the chassis 10 from moving relative to the ground. In a manner known per se and not discussed in detail herein, the brake release device 40 includes e.g. one or a plurality of springs which, when the brake release device 40 is deactivated, apply brakes against the wheels and/or against an element of the mechanical transmission kinematically connected to the wheels. In order to activate the brake release device 40 and thereby allow the wheels 11A and 11B to be driven freely by the motor-drive 30, the aerial lift 1 includes a hydraulic actuator 50 acting on the brake release device 40: when the hydraulic actuator 50 is actuated, same activates the brake release device 40, e.g. by neutralizing or overcoming the force of the aforementioned spring(s) so as to move apart the brakes normally applied by the springs. In FIG. 2, the brake release device 40 is schematically illustrated as including two elements 40.1 and 40.2, which act mechanically on the transmission shaft 14B of the rear axle 12B, on either side of the differential 15B, and which can be activated by two respective elements 50.1 and 50.2 of the hydraulic actuator 50. In practice, the brake release device 40 and the hydraulic actuator 50 are supported by the chassis 10. Of course, in a variant not shown, the non-limiting arrangements which have just been described with reference to FIG. 2 for the brake release device 40 and the hydraulic actuator 50 at the transmission shaft 14B may be provided, either as a replacement or as a supplement, at the drive shaft 14A.

According to an advantageous optional arrangement, which is implemented in the embodiment illustrated in the figures, the differential 15B of the drive shaft 14B of the rear drive axle 12B can be locked by a locking device 60, which is known per se and which is shown only schematically in FIG. 2. The locking device 60 makes it possible, when activated, to lock the differential 15B so that the two rear wheels 11B are forced to turn at the same speed even if one of the wheels is slipping or turns in a void, in particular because of an uneven ground condition. In order to activate the locking device 60 and thereby lock the differential 15B, the aerial lift includes a hydraulic actuator 70 acting on the locking device 60: when the actuator 70 is actuated, same activates the locking device 60, e.g. by forcing a direct bridging on either side of the differential 15B. In practice, the locking device 60 and the hydraulic actuator 70 are supported by the chassis 10. Of course, in a variant (not shown), as a replacement of or in addition to the locking device 60 and to the associated hydraulic actuator 70, a locking device and a hydraulic actuator, correspondingly similar to the latter, may be provided for the differential 15A.

According to another advantageous optional arrangement, which is also implemented in the embodiment illustrated in the figures, the front axle 13A is oscillating, i.e. is mounted on a fixed part of the chassis 10 so as to be able to rotate about a front-to-back geometric axis of the chassis, extending parallel to the ground and passing through the middle of the front drive axle 12A. Such an oscillating assembly for the axle 13A is known per se in the art, more particularly in the field of aerial lifts, and the specificities of the oscillating assembly are not limiting. Moreover, the reader may refer to document EP 3 792 213 for a detailed example of such specificities. Whatever the specificities may be, the aerial lift 1 includes one or a plurality of hydraulic actuators which act on the front axle 13A to control the oscillation of the latter and which, herein, are two power cylinders 80 and 81, as illustrated schematically in FIG. 2. The power cylinders 80 and 81 are supported by the chassis 10 and are loaded with fluid so as to be held in abutment on the front drive axle 12A. When the power cylinders 80 and 81 are actuated, the power cylinders, the fluid supply of which is maintained by boosting in particular to compensate for leaks, are freely deployable by the circulation of fluid therebetween, so as to allow the front axle 13A to oscillate freely, which is typically to be implemented when the lift 1 moves on the ground to allow the axle 13A to follow potential ground irregularities. When the cylinders 80 and 81 are not actuated, same are locked, being prevented from modifying the deployment thereof, and thereby lock the front axle 13A in oscillation, which is typically to be implemented when the aerial lift 1 is stationary on the ground and deployed at height. Here again, a more detailed example of the operation of the power cylinders 80 and 81 is given in EP 3 792 213 to which the reader may refer. Of course, in a variant (not shown), the rear axle 13B can be provided to oscillate, in replacement of or as an addition to the oscillation for the front axle 13A, by means of arrangements similar to what has just been described for the front axle 13A.

As shown in FIG. 1, the aerial lift 1 further comprises a platform 100 which is designed so that the operator using the aerial lift can stand on the platform. The platform 100 is thereby designed for receiving the operator on-board and, where appropriate, one or more other persons and/or equipment for carrying out work at height. For this purpose, the platform 100 comprises a floor 101 on which the operator stands, and a guardrail 102 which rises from the floor 101 and surrounds the platform 100. In addition, the platform 100 is equipped with a control console 103 enabling the operator on-board the platform to control the movement of the chassis 10 on the ground and the operation of a lifting structure 110 of the aerial lift 1, supporting the platform 100.

The lifting structure 110 is arranged on the chassis 10 so as to be apt to move the platform 100 with respect to the chassis at least at height. To this end, the lifting structure 110 comprises a turret 111 which rests on the chassis 10 and which can rotate with respect to the latter about an axis of rotation extending perpendicularly to the ground, and an arm 112 which connects the turret 111 to the platform 100 and which is deployable so as to move away, the platform 100 from the turret 111, to a greater of lesser extent, more particularly upwards and laterally from the turret. In practice, the embodiment of the turret 111 is not limiting. Similarly, the embodiment of the arm 112 is limiting: moreover, the term “arm” used herein is understood in a broad sense and thereby corresponds to an elongate mechanical structure, including a plurality of arm elements movable with respect to one another, for the purpose of deploying the mechanical structure. In the example shown in FIG. 1, the arm 112 is an articulated arm, details of which are provided in FR 3 067 341 to which the reader may refer. In a variant (not shown), the arm 112 is at least partially telescopic, including arm elements that fit into one another.

More generally, the invention is not limited to the embodiment of the lifting structure 110 because, by moving parts of the lifting structure with respect to each other and/or with respect to the chassis 10, the positioning of the platform 100 with respect to the chassis 10 is modified accordingly, since the displacement of platform can thereby be controlled, by means of the lifting structure 110, by the operator using the aerial lift 1, more particularly from the platform 100 by means of the control console 103.

Whatever the embodiment for the lifting structure 110, the movable parts of the latter can be driven in motion with respect to each other and/or with respect to the chassis 10 by hydraulic actuators 120, which are integrated into the aerial lift 1 and only one of which is shown diagrammatically in FIG. 2. Thereby, in the embodiment considered herein, the hydraulic actuators 120 act on the turret 111 for the purpose of setting same in rotation, as well as on the arm 112 for the purpose of deploying same. As such, the hydraulic actuators 120 are known in the field of aerial lifts and the embodiment of each of them is not limiting, being obviously suitable for the range of the lifting structure 110 on which the hydraulic actuator 120 acts. As an example, each of the hydraulic actuators 120 is a single-acting power cylinder, a double-acting power cylinder, a rotary actuator, etc.

The hydraulic system S of the aerial lift 1 serves, by means of arrangements which will be presented hereinafter, to actuate the hydraulic actuators 20, 50, 70, 80 and 81 and 120 which have been described hitherto, by supplying same with fluid. To this end, as shown in FIG. 2, the hydraulic system S includes a reservoir 130 containing a sufficient quantity of fluid for the operation of the hydraulic system S, and a circulation circuit 140 through which the fluid circulates between the reservoir 130 and the hydraulic actuators 20, 50, 70, 80, 81 and 120. In addition, the aerial lift 1 includes a control unit 150 for controlling the hydraulic system S for the purpose of actuating the hydraulic actuators 20, 50, 70, 80 and 81 and 120. In practice, the control unit 150 includes a calculator or similar electronic components and is suitable for transmitting control signals to the hydraulic system S, in particular electrical signals. The control console 103 is connected to the control unit 150 by any appropriate means so that the control unit 150 is servo-controlled by the control console 103, enabling the operator on board the platform to control the hydraulic system S.

The circulation circuit 140 includes a pump unit 170 which is used to circulate, the fluid in the circulation circuit 140 under pressure. The pump unit 170 can be driven by the internal combustion engine 31, being mechanically connected to the drive output of the latter. The pump unit 170 is connected to the reservoir 130 by a suction line 171 so as to be able to suck in the fluid from the reservoir 130. The pump unit 170 is connected to a discharge line 172 into which the pump unit, when driven, discharges the fluid under a discharge pressure. The discharge pressure is variable, according to a pressure regulation. To this end, according to a preferential embodiment, both practical and economical, which is implemented in FIG. 2, the pump unit 170 includes a variable displacement pump 173, as well as a regulator 174. The pump 173 sucks in the fluid from the reservoir 130 via the suction line 171 and discharges the fluid under the discharge pressure into the discharge line 172. The regulator 174, which implements the regulation of the pressure of the pump unit 170, acts on a control member 175, herein a power cylinder, which controls the displacement of the pump 173. The regulator 174 thereby serves to adjust the displacement of the pump 173 in order to obtain a constant pressure differential between the pressure in the discharge line 172 and the pressure at an inlet 176 of the regulator 174. Thereof is equivalent to saying that, in service, the regulator 174 maintains the discharge pressure in excess pressure with respect to the pressure at the inlet 176, with an overpressure value which is constant and which corresponds to the aforementioned pressure differential. As a non-limiting example, the pressure differential is equal to about 20 bar. In practice, multiple embodiments, known as such in the art, can be envisaged for the regulator 174 for the purpose of regulating the pressure of the pump unit 170 and are thus not limiting: as an example, in the embodiment illustrated in FIG. 2, the regulator 174 comprises a first regulation member which serves to maintain the pressure of the discharge line 172 at a value corresponding to the pressure of the inlet 176 incremented by the aforementioned pressure differential by acting on the displacement of the pump 173 via the control member 175. A second regulation member serves to cancel the displacement of the pump 173 when the pressure in the discharge line 172 reaches the preset maximum pressure value.

The circulation circuit 140 further includes a booster unit 180 which, as explained hereinbelow, performs two main functions, namely providing boosting with fluid and controlling the pressure regulation of the pump unit 170.

At the inlet, the booster unit 180 is connected to the discharge line 172 by a branched-off supply line 181 so as to be supplied with fluid under the discharge pressure from the discharge of the pump unit 170.

At the outlet, the booster unit 180 is connected to a booster line 182 wherein the booster unit 180 sends the fluid from the branched-off supply line 181 by regulating the pressure thereof to a booster pressure. The booster pressure has a predetermined value which, in an example considered here, is equal to about 27 bar. To this end, the booster unit 180 includes a pressure reducer 183 which connects the branched-off supply line 181 to the booster line 182. The pressure reducer 183 also connects the booster line 182 to a drainage line 131 connected to the reservoir 130, thereby limiting the pressure of the fluid in the booster line 182 to the booster pressure.

In addition, the booster unit 180 is designed to control the pressure regulation of the pump unit 170 so as to bring the pressure of the fluid discharged by the pump unit 170 into the discharge line 172, in other words the discharge pressure, at a value sufficiently high to satisfy the operating requirements of the aerial lift 1. More precisely, the pressure regulation is controlled by the booster unit 180 taking into account at least the following three operating situations:
in a first operating situation, wherein the aerial lift 1 is controlled to move the lifting structure 110 and/or to orient the wheels 11A and 11B, without being controlled to move in translation on the ground, in other words, when at least one of the hydraulic actuators 20 and 120 is actuated without the hydraulic actuators 50, 70, 80 and 81 being actuated, the booster unit 180 controls the pressure regulation in such a way that the discharge pressure is greater than a load pressure of the actuator or actuators which are controlled to actuate among the hydraulic actuators 20 and 120, the load pressure having a variable value, which depends on the work supplied by the actuator or the actuators controlled by actuation to move the lifting structure 110 and/or to orient the wheels 11A and 11B and which, in practice, can reach several tens or even several hundreds of bar;
in a second operating situation, where the aerial lift 1 is controlled to move in translation on the ground, without being controlled to move the lifting structure 110 and/or to orient the wheels 11A and 11B, in other words when the hydraulic actuator 50 and, where appropriate, at least one of the hydraulic actuators 70, 80 and 81 is actuated without the hydraulic actuators 20 and 120 being actuated, the booster unit 180 controls the pressure regulation so that the discharge pressure is higher than the booster pressure; and
in a third operating situation, wherein the aerial lift 1 is, at the same time, controlled to move the lifting structure 110 and/or to orient the wheels 11A and 11B and controlled to move in translation on the ground, in other words when at least one of the hydraulic actuators 20 and 120, the hydraulic actuator 50 and, where applicable, one of the hydraulic actuators 70, 80 and 81 are actuated, the booster unit 180 controls the pressure regulation so that the discharge pressure is higher than the maximum between load pressure and the booster pressure.

To this end, according to a preferred embodiment, which is both practical and economical, and is implemented in FIG. 2, the booster unit 180 is connected to the hydraulic actuators 20 and 120 by a first load line 184, which is at load pressure, and is connected to the pump unit 170 by a second load line 185 which is connected to the inlet 176 of the regulator 174 of the pump unit 170. Thereby, the booster unit 180 controls the pressure regulation of the pump unit 170 by adjusting the discharge pressure to the pressure of the load line 185, plus the pressure differential provided by the regulator 174. In addition, the booster unit 180 includes a solenoid valve 186 which is controlled by the control unit 150 and which is provided on a branch of the booster unit 180, connecting the branched-off supply line 181 and a pressure reducer 187 of the booster unit. The pressure reducer 187 also connects the aforementioned branch of the booster unit to the drainage line 131, thereby making it possible to regulate the pressure of the fluid in said branch. In the non-actuated position, the solenoid valve 186 isolates the branched-off supply line 181 from the pressure reducer 187, whereas in the actuated position, the solenoid valve 186 places the branched-off supply line 181 in communication with the pressure reducer 187. The solenoid valve 186 is designed to be in the non-actuated position in the first operating situation and to be in the actuated position in the second and third operating situations: thereby, when the hydraulic actuators 50, 70, 80 and 81 are not actuated, the solenoid valve 186 prevents the flow of fluid through same from the branched-off supply line 181 to the pressure reducer 187, whereas when the hydraulic actuator 50 and, where appropriate, at least one of the hydraulic actuators 70, 80 and 81 are actuated, the fluid from the branched-off supply line 181 reaches, via the solenoid valve 186, the pressure reducer 187 which applies a reduction to the pressure of the branched-off supply line 181. The booster unit 180 further includes a selector 188 which is connected to the outlet of the pressure reducer 187 and to the load lines 184 and 185. The selector 188 puts the load line 185 in communication with the line between the outlet of the pressure reducer 187 and the load line 184, which has the highest pressure. In other words, the selector 188 sends to the load line 185, the fluid having the highest pressure between the fluid leaving the pressure reducer 187 and the fluid in the load line 184.

On the basis of the embodiment of the booster unit 180 which has just been described and which is not limiting, it should be understood that the pressure of the load line 185 is controlled by the booster unit 180 to be:
the pressure of the load line 184, in the first operating situation,
a reduction in the discharge pressure, in the second operating situation, and
the maximum between the pressure of the load line 184 and the abovementioned reduction in the discharge pressure, in the third operating situation.

In practice, the aforementioned reduction of the discharge pressure, which is produced by the pressure reducer 187 in the embodiment illustrated in the figures, has a value set so that the load pressure is smaller than the sum of the pressure differential and said reduction; as an example, the reduction is approximately 15 bar. Henceforth, the discharge pressure is, in the three aforementioned operating situations, raised by the pump unit 170 to a sufficiently high value to satisfy the operating requirements of the aerial lift 1.

As an advantageous optional arrangement, the booster unit 180 moreover includes a solenoid valve 189 which is provided on a branch of the booster unit 180, connecting the load line 185 and the drainage line 131 connected to the reservoir 130. In the actuated position, the solenoid valve 189 isolates the load line 185 and the drainage line 131 from each other, whereas, in the non-actuated position, the solenoid valve 189 places same in communication with each other. The solenoid valve 189 is controlled by the control unit 150: in the three aforementioned operating situations, the control unit 150 switches the solenoid valve 189 to the actuated position. The advantage of the solenoid valve 189 thereby lies in another operating situation of the aerial lift 1, namely when the internal combustion engine 31 is turned on without, however, actuating any of the hydraulic actuators 20, 50, 70, 80, 81 and 120: in such case, although the pump unit 170 is driven by the internal combustion engine 31, the energy consumption thereof remains very limited since the pressure of the load line 185 is substantially zero, which means that, as a result of the pressure regulation of the pump unit 170, the discharge pressure is limited to the aforementioned pressure differential. In the example mentioned hereinabove, the discharge line 172 is thereby maintained at a pressure of about 20 bar, without any working flow.

In order to control the actuation of the hydraulic actuators 20 and 120, the circulation circuit 140 includes a main manifold unit 190. The main manifold unit 190 is, for the purpose the supply thereof with fluid, connected to the discharge line 172 by a main supply line 191. As illustrated schematically in FIG. 2, the main manifold unit 190 includes, for each of the hydraulic actuators 20 and 120, a directional control valve 192 which controls the actuation of the hydraulic actuator concerned, by allowing fluid from the main supply line 191 to be sent to that hydraulic actuator when that hydraulic actuator is to be actuated, and by interrupting the supply of fluid when the hydraulic actuator is not to be actuated, where appropriate, by discharging an excess of fluid toward the reservoir 130 via a drainage line 193. In practice, the respective embodiments of the directional control valves 192 are adapted to the actuator with which each of them is associated among the hydraulic actuators 20 and 120, the embodiments not being limiting. For example, the directional control valves 192 are solenoid valves, where appropriate with a plurality of ways and/or with N positions, N being greater than or equal to two. In any case, the directional control valves 192 are controlled individually by the control unit 150 so as to lead to a selective actuation of the hydraulic actuators 20 and 120, depending upon control instructions coming from the control unit 150. More generally, whatever the specificities of the directional control valves 192, the main manifold unit 190 makes it possible to actuate the hydraulic actuators 20 and 120, by sending the fluid from the main supply line 191 selectively to the actuator or actuators to be actuated among the hydraulic actuators 20 and 120. In practice, the locations where the directional control valves 192 are integrated in the aerial lift 1 are not necessarily grouped together: for example, the directional control valve 192 associated with the hydraulic actuator 20 can be supported by the chassis 10 whereas the other directional control valves 192 are integrated into the lifting structure 110.

In addition, the main manifold unit 190 is connected to the booster unit 180 through the load line 184. The main manifold unit 190 is designed, whatever the actuator or actuators which are actuated by the directional control valves 192 among the hydraulic actuators 20 and 120, to set the load line 184 to the load pressure of the actuator or the actuators that are actuated. In practice, when a plurality of actuators among the hydraulic actuators 20 and 120 are simultaneously actuated, the load pressure in the load line 184 corresponds to the maximum value of the individual load pressures of the actuated actuators. One way of setting the load line 184 to the highest load pressure of the controlled hydraulic actuators 20 and 120 is to use pressure selectors between the lines connected to the hydraulic actuators, or disk valves between the lines connected to the hydraulic actuators and the load line 184.

In order to control the actuation of the hydraulic actuators 50, 70, 80 and 81, the circulation circuit 140 includes an accessory manifold unit 200. The accessory manifold unit 200 is, for the purpose of supply thereof with fluid, connected to the discharge line 172 through an accessory supply line 201.

The accessory manifold unit 200 includes a solenoid valve 202 which is controlled by the control unit 150. In the actuated position, the solenoid valve 202 serves to send therethrough the fluid from the accessory supply line 201 to the hydraulic actuator 50 and thereby to actuate the latter so as to activate the brake release device 40 as explained hereinabove. In the non-actuated position, the solenoid valve 202 isolates the hydraulic actuator 50 from the accessory supply line 201 and puts the hydraulic actuator 50 in communication with a drainage line 203 connecting the accessory manifold unit 200 to the reservoir 130, which deactivates the brake release device 40, as explained hereinabove. The solenoid valve 202 thereby serves to control the actuation of the hydraulic actuator 50.

The accessory manifold unit 200 further includes a solenoid valve 204, which is similar to the solenoid valve 202, more particularly being controlled by the control unit 150, but which, unlike the solenoid valve 202, serves to control the actuation of the hydraulic actuator 70 and, thereby, the activation of the locking device 60 described hereinabove.

The accessory manifold unit 200 further includes two solenoid valves 205 and 206, which are controlled by the control unit 150 and which serve to control the cylinders 80 and 81, while ensuring the boosting of the cylinders, whether or not the latter are actuated, by using the fluid from the accessory supply line 201. The actuation of the cylinders 80 and 81 has been explained hereinabove, for the purpose of controlling the oscillation of the front axle 13A. According to considerations presented in detail in EP 3 792 213 to which the reader may refer, the respective inputs of the solenoid valves 205 and 206 are connected to each other by a branch of the accessory manifold unit 200, connected to the accessory supply line 201 by a pressure reducer 207.

Thereby, the accessory manifold unit 200 is designed to control the actuation of the hydraulic actuators 50, 70, 80 and 81, by sending the fluid from the accessory supply line 201 selectively to the actuator or actuators to be actuated among the actuators 50, 70, 80 and 81. It should be noted that, in addition to or in replacement of the hydraulic actuator 70, which performs the accessory function of activating the locking device 60, and in addition to or in replacement of the cylinders 80 and 81, which perform the accessory function of controlling the oscillation of the front axle 13A, one or a plurality of other hydraulic actuators may equip the aerial lift 1 to perform one or a plurality of other functions accessory to the operation of the aerial lift by acting on corresponding accessory parts of the aerial lift, similarly to the action of the hydraulic actuator 70 on the locking device 60 and to the action of the cylinders 80 and 81 on the front axle 13A. In such case, the accessory manifold unit 200 includes, for each of the additional hydraulic actuators, a directional control valve which is controlled by the control unit 150 and which controls the actuation of the hydraulic actuator concerned, by making it possible to send to the hydraulic actuator, the fluid from the accessory supply line 201 when the hydraulic actuator is to be actuated. On the other hand, a variant (not shown) consists in limiting the accessory manifold unit 200 to the solenoid valve 202, i.e. that, more generally, the accessory manifold unit 200 may be limited to being able to control the actuation of the hydraulic actuator 50 for the purpose of activating the brake release device 40, insofar as the aerial lift 1 should always have the corresponding brake release function. In practice, the directional control valve(s) of the accessory manifold unit 200 are integrated into the aerial lift 1 at respective locations which are not limiting and which are preferentially suitable for the hydraulic actuator which each of same controls.

According to advantageous optional arrangements, which are implemented in FIG. 2, the fluid leaving the booster unit 180 via the booster line 182, in addition to being used by the accessory manifold unit 200, is used in connection with the hydrostatic transmission 32. To this end, the circulation circuit 140 includes a compensation device 210 and a directional control valve 211 which are connected to the booster line 182 by a connecting line 212 so as to be supplied with fluid by the booster line. The compensation device 210 is designed to feed fluid into the closed circuit 35 to compensate for the losses of the latter. The compensation device 210 is, as such, known in the art, more particularly in the field of aerial lifts, and will not be described hereinafter. Whatever the embodiment specificities, the compensation device 210 serves, by means of the fluid same feeds into the closed circuit 35, to compensate for any leaks in the closed circuit, as well as to renew the fluid of the closed circuit by replacing withdrawals which are regularly carried out from the closed circuit 35, in particular by the scavenging valve 37 for the purpose of renewing and, if appropriate, cooling the fluid of the closed circuit 35. The directional control valve 211 is designed to act on the control member 36 which, as indicated hereinabove, serves to adjust the displacement of the hydraulic pump 33. Here again, the directional control valve 211, in that same acts on the control member 36, is known per se and will thus not be described hereinafter, the embodiment thereof not being limiting.

Taking into account the explanations given hitherto, the operation of the aerial platform 1 will be described hereinafter by considering different phases of operation, which frequently occur in the field and which potentially follow one another, in an indifferent order. In all the operating phases considered hereinafter, the internal combustion engine 31 works and thus drives the pump 173 of the pump unit 170.

In a first phase of operation, the operator of the aerial lift 1 does not give any control instruction to the aerial lift. The aerial lift 1 thus remains stationary, in particular under the effect of the brake release device 40 which remains deactivated. The solenoid valves 186 and 189 are in the non-actuated position so that the pressure in the load line 185 is zero and that, under the effect of the regulator 174, the discharge pressure at the outlet of pump 173 is limited to the pressure differential mentioned hereinabove, i.e. e.g. 20 bar.

In a second phase of operation, the operator gives instructions, in particular via the control console 103, so that, without setting the lifting structure 110 in motion, the aerial lift 1 moves forwards on the ground in a straight line, thus without having to orient the wheels 11A to the left or to the right. The control unit 150 then switches the solenoid valves 186, 189 and 202 to the actuated position. The fluid in the discharge line 172, the pressure of which may initially be limited to the pressure differential, accesses, via the solenoid valve 186, the pressure reducer 187 and applies to the selector 188, the reduction, e.g. of 15 bar, output by the pressure reducer 187. Since the load pressure in the load line 184 is zero, the selector 188 allows the reduction to pass, which pressurizes the load line 185 to the value of the reduction. Under the effect of the regulator 174, the discharge pressure at the outlet of the pump 173 is brought to a value corresponding to the sum between the reduction and the pressure differential, i.e., in the example considered hitherto, the sum between 15 bar and 20 bar. The fluid under the discharge pressure passes through the booster unit 180 where the reducer 187 limits the pressure thereof to the booster pressure, i.e. e.g. 27 bar, before reaching the accessory manifold unit 200 via the accessory supply line 201. The fluid then passes through the solenoid valve 202 in the actuated position to actuate the hydraulic actuator 50 and thereby activate the brake release device 40 to allow the aerial lift 1 to move in translation on the ground.

In a third phase of operation, the operator gives instructions, in particular via the control console 103, so that the aerial lift 1 moves simultaneously on the ground, where appropriate by turning, and so that the lifting structure 110 moves the platform 100 with respect to the chassis 10. The control unit 50 then switches or maintains the solenoid valves 186, 189 and 202 in the actuated position. The fluid in the discharge line 172 accesses, via the solenoid valve 186, the pressure reducer 187 and applies to the selector 188, the reduction, e.g. of 15 bar, output by the pressure reducer 187. The selector 188 allows the fluid having the highest pressure to pass between the reduction and the load pressure in the load line 184, the load pressure being raised to a substantial value which depends on the work supplied by one or a plurality of the hydraulic actuators 120 controlled in actuation to act on the lifting structure 110, as well as, where appropriate, by the hydraulic actuator 20, so as to turn wheels 11A and 11B to the left or to the right. In general, the value of the load pressure is greater than the reduction produced by the pressure reducer 187: herein is considered, e.g., that the load pressure is equal to one hundred bar. The load line 185 is pressurized with the fluid that the selector 188 allows to pass, i.e. at the aforementioned hundred bar. Under the effect of the regulator 174, the discharge pressure at the outlet of the pump 173 is raised to a value corresponding to the sum between the pressure differential and the pressure of the fluid in the load line 185, i.e., herein, the sum between 20 bar and the aforementioned hundred bar. The fluid under the discharge pressure is, on the one hand, sent to the main manifold unit 190 to enable actuation of the actuators 120 and optionally 20 to be actuated and, on the other hand, passes through the booster unit 180 where the reducer 187 limits the pressure thereof to the booster pressure, i.e. e.g. 27 bar, before reaching the accessory manifold unit 200 where same actuates the hydraulic actuator 50 after having passed through the solenoid valve 202 in the actuated position.

In a fourth phase of operation, the operator gives instructions, in particular via the control console 103, so that the lifting structure 110 moves the platform 100 with respect to the chassis 10 and/or so that the wheels 11A are oriented to the left or to the right, without moving the frame relative to the ground. The control unit 150 switches or maintains the solenoid valve 189 in the actuated position and [maintains] the solenoid valves 186 and 202 in the non-actuated position. Since the solenoid valve 202 is in the non-actuated position, all or part of the wheels 11A and 11B are locked by the non-activated brake release device 40. Moreover, since the pressure output by the pressure reducer 187 is zero since the solenoid valve 186 isolates the latter from the branched-off supply line 181, the selector 188 allows the fluid coming from the load line 184 to pass through, which pressurizes the load line 185 to the value of the pressure of the load line 184, e.g. one hundred bar, as envisaged in the example hereinabove. Under the effect of the regulator 174, the discharge pressure at the outlet of the pump 173 is raised to a value corresponding to the sum of the pressure differential and the pressure in the load lines 184 and 185, i.e. the sum between 20 bar and one hundred bar. The fluid under the discharge pressure is sent to the main manifold unit 190 to enable the actuation of the actuator or actuators 20 and/or 120 to be actuated and thereby move the lifting structure 110.

It should be noted that in the various phases of operation envisaged hereinabove, as well as in other potential phases of operation, the control instructions given by the control unit 150 may, partially or totally, not result from instructions given by the operator via the control console 103, but from an automatic pilot unit that applies predetermined protocols, including safety protocols for the aerial lift 1.

FIG. 3 shows an alternative embodiment to the aerial lift 1, which is referenced by 1′. The aerial lift 1′ is identical to the aerial platform 1, except for motor-drive, referenced by 30′ instead of 30. The motor-drive 30′ differs from the engine 30 by the fact that same does not rely on an internal combustion engine, such as the internal combustion engine 31 of the aerial lift 1 but includes one or a plurality of electric motors. In the embodiment considered in FIG. 3, the motor-drive 30′ thereby includes two electric motors, namely an electric motor 31′, the power output of which is in engagement with the gearbox 16 for the purpose of driving the wheels 11A and 11B of the aerial lift 1′, and an electric motor 32′, the power output of which is engaged with the pump 173 for the purpose of driving the pump unit 170. More generally, it should be understood that, whatever the specificities of the electric motor 30′, same drives the wheels 11A and 11B and drives the pump unit 170.

It results therefrom that, compared to the aerial lift 1, the aerial lift 1′ is devoid of both an internal combustion engine such as the internal combustion engine 31 and of an associated hydrostatic transmission such as the hydrostatic transmission 32, as well as of hydraulic devices specific to such a hydrostatic transmission, such as the compensation device 210 and the directional control valve 211. For the rest, the aerial lift 1′ has exactly the same components as the aerial lift 1, so that, in FIG. 3, the latter are identified with the same references as the references used in FIG. 2. Thereof illustrates the fact that the hydraulic system S shown in detail in FIG. 2 can be equally used for both internal combustion and electrical versions of the same lift.

Finally, various arrangements and variants of the elevating lifts 1 and 1′ which have been hitherto described, can be envisaged. Examples include:
within the lifting structure 110, the rotary turret 111 can be replaced by a fixed base; and/or
as mentioned hereinabove, the elements belonging to the booster unit 180, the main manifold unit 190 and the accessory manifold unit 200 are integrated into the aerial lift 1 at respective locations which are not limiting; thereof is equivalent to saying that the booster units 180, the main manifold unit 190 and the accessory manifold unit 200 which have been presented hereinabove are understood from a functional point of view, not from a structural point of view; thereby, all or part of the functions of one of the units can be provided by elements arranged at the same location as elements of another of the units, providing all or part of the functions of the other unit.

1. An aerial lift, including:
a motor-drive by internal combustion engine or by electric motor,
a chassis equipped with ground translation members which can be driven by the engine to move the chassis with respect to the ground,
a platform suitable for one operator standing thereon,
a lifting structure, which supports the platform and which is arranged on the chassis so as to be able to move the platform at height with respect to the chassis, and
a hydraulic system comprising a reservoir, hydraulic actuators and a circulation circuit through which fluid flows between the reservoir and the hydraulic actuators, the circulation circuit comprising:
a pump unit, which is connected to the reservoir in such a way as to suck the fluid from the reservoir and which can be driven by the motor in such a way as to discharge the fluid into a discharge line at a discharge pressure which is variable according to a pressure regulation,
a main manifold unit, which is connected to the discharge line by a main supply line and which controls the actuation of first actuators to actuate, the first actuators including actuators acting on portions of the lifting structure so as to move the portions relative to the rest of the lifting structure or relative to the chassis,
a booster unit, which is connected to the discharge line by a branched-off supply line and which sends the fluid from the branched-off supply line into a booster line by regulating the pressure thereof to a booster pressure the value of which is preset, and
an accessory manifold unit, which is connected to the booster line by an accessory supply line and which controls the actuation of one or a plurality of second actuators being distinct from the first actuators and acting on accessory portions of the aerial lift, the or one of the second actuators thereby acting on a brake release device which, in the non-activated state, brakes at least some of the ground translation members,
wherein the booster unit controls said pressure regulation in such a way that:
when at least one of the first actuators controlled,
when the or at least one of the second actuators, including the actuator acting on the brake release device, is actuated without the first actuators being actuated, the discharge pressure is higher than the load pressure, and
when at least one of the first actuators and the or at least one of the second actuators, including the actuator acting on the brake release device, are actuated, the discharge pressure is higher than the maximum between the load pressure and the load pressure.

2. The aerial lift according to claim 1,
wherein the booster unit is connected to the main manifold unit by a first load line which is at the load pressure, and is connected to the pump unit by a second load line, the pressure of which is controlled by the booster unit so as to be:
the pressure of the first load line when at least one of the first actuators being actuated,
a reduction of the discharge pressure when the or at least one of the second actuators, including the actuator acting on the brake release device, is actuated without the first actuators being actuated, and
the maximum between the pressure of the first load line and said reduction of the discharge pressure when at least one of the first actuators and the or at least one of the second actuators, including the actuator acting on the brake release device, are actuated, and
wherein the booster unit controls the pressure regulation of the pump unit by adjusting the discharge pressure to the pressure of the second load line, increased by a constant pressure differential.

3. The aerial lift according to claim 2, wherein the booster unit includes:
a pressure reducer which regulates the pressure of the fluid passing therethrough to said reduction of the discharge pressure,
a solenoid valve which:
puts the branched-off supply line in communication with the pressure reducer when the or at least one of the second actuators, including the actuator acting on the brake release device, are actuated, and
isolates the branched-off supply line from the pressure reducer when the second actuator or actuators are not actuated, and
a selector which sends to the second load line the fluid having the highest pressure between the fluid leaving the pressure reducer and the fluid from the first load line.

4. The aerial lift according to claim 1, wherein the booster unit includes a pressure reducer which connects the branched-off supply line and the booster line and which regulates the pressure of the fluid passing therethrough to the booster pressure.

5. The aerial lift according to claim 1, wherein the pump unit includes:
a variable displacement pump, which sucks in the fluid from the reservoir and which discharges the fluid into the discharge line, and
a regulator, which implements said pressure regulation and which acts on a control member, such as a cylinder, controlling the displacement of the pump.

6. The aerial lift according to claim 1, wherein the ground connecting members are distributed in at least two pairs of ground connecting members, the two ground connecting members of each pair are carried by the opposite ends, respectively, of the same drive axle and form with the latter an axle of the chassis.

7. The aerial lift according to claim 6,
wherein at least one of the drive axles comprises a drive shaft which transmits the drive from the motor-drive to the ground translation members supported by the drive axle and which includes a differential.
and wherein the second actuators include, for the or at least one of the differentials, an actuator acting on a locking device which, in the activated state, locks the differential concerned.

8. The aerial lift according to claim 6,
wherein the or at least one of the axles is oscillating, and wherein the second actuators include, for the or each oscillating axle, cylinders which bear on the drive axle concerned so as to control the oscillation thereof.

9. The aerial lift according to claim 1, wherein the first actuators include at least one actuator acting on the orientation of at least some of the ground translation members relative to the frame to change the direction along which the chassis translates on the ground.

10. The aerial lift according to claim 1,
wherein the motor includes an internal combustion engine which is mechanically connected to the pump unit to drive the latter,
wherein the hydraulic system comprises a hydrostatic transmission having a hydraulic pump, which is mechanically connected to the internal combustion engine, a hydraulic motor, which is mechanically connected to the ground translation members for driving the latter, and a closed circuit wherein fluid flows between the hydraulic pump and the hydraulic motor, and
wherein the circulation circuit includes a compensation device, which is suitable for feeding fluid into the closed circuit to compensate for losses, the compensation device being connected to the booster line.

11. The aerial lift according to claim 10, wherein the hydraulic pump has a variable displacement, and wherein the circulation circuit includes a directional control valve which acts on a control member, such as a cylinder, controlling the displacement of the hydraulic pump, the directional control valve being connected to the load line.

12. The aerial lift according to claim 1, wherein the motor comprises one or a plurality of electric motors which drive both the ground translation members and the pump unit.
